(19) United States
(12) Patent Application Publication
(10) Pub. No.: US 2020/0320054 A1
(43) Pub. Date: Oct. 8, 2020

(54) COMPUTER PROGRAM FOR PROVIDING DATABASE MANAGEMENT

(71) Applicant: TmaxData Co., Ltd., Seongnam-si (KR)

(72) Inventors: Woojin KIM, Suwon-si (KR); Joo Hyun LEE, Namyangju-si (KR); Sang Young PARK, Seongnam-si (KR)

(21) Appl. No.: 16/425,630

(22) Filed: May 29, 2019

(30) Foreign Application Priority Data
Apr. 5, 2019 (KR) 10-2019-0040251

(51) Int. Cl. G06F 16/22; G06F 7/08

(52) U.S. Cl. CPC G06F 16/2282; G06F 7/08

(57) ABSTRACT

An embodiment of the present disclosure discloses a computer program executable by one or more processors and stored in a computer readable medium. The computer program causes the one or more processors to perform operations for database management, the operations including: generating a sorted table by sorting a table including one or more records based on at least one column; identifying a current key corresponding to each of one or more rows included in the sorted table; sequentially recording a record corresponding to each of the one or more rows in a data structure based on a result of a comparison between the current key corresponding to each of the one or more rows and a previous key; and generating an integrated result value for a record recorded in the data structure and recording the generated integrated result value in an output table.

### CROSS-REFERENCE TO RELATED APPLICATIONS

This application claims priority to and the benefit of Korean Patent Application No. 10-2019-0040251 filed in the Korean Intellectual Property Office on Apr. 5, 2019, the entire contents of which are incorporated herein by reference.

### TECHNICAL FIELD

The present disclosure relates to a database management, and more particularly, to a computer program for improving processing performance of a database.

### BACKGROUND ART

A database means a set of standard data that is integrated and managed for the purpose of being shared and used by many people. In general, data associated with a specific region of one organization may be collected, and the collected data may be used for providing information for supporting decision making at several levels.

As the amount of data becomes larger today, in order to search for and change required data in a database, a database management system (hereinafter, a “DBMS”) for efficiently supporting the search for and the change of the data in the database is increasingly utilized.

The DBMS may store all of the data in the database in the form of a table, and express and provide data to a user in the form of a relation. That is, the DBMS may provide the data in the form of a bunch of tables consisting of a set of rows and columns, and provide a relational operator that is capable of manipulating the data in a tabular format.

The table refers to a basic structure storing data in the database, and one table consists of one or more records. When a specific query is input from the outside, the DBMS may obtain a desired output from the table in response to the input query.

Herein, the query means a specific demand for the data stored in the table of the database, that is, a description of the kind of desired manipulation for data, and may be expressed with a language, such as the Structured Query Language (SQL).

In the meantime, a demand for big data analysis has been continuously increased recently, and a size of data to be analyzed has been continuously grown. A desire for increasing a business success probability through decision making based on the big data analysis is increasing, and the improvement of performance of the big data analysis is becoming an essential technology in a real-time enterprise environment.

In order to analyze more extensive data and make decisions at different levels, multi-directional analysis of a database may be required, and to this end, there may be a demand for a cumulative operation value and the like based on each of the various levels for one or more records included in the table of the database.

However, in the DBMS in the related art, when a level-specific total is obtained based on a column in a specific table, an operation is performed based on each level of the column existing in the table, so that there is a concern in increasing the amount of operation.

Accordingly, the industry in the art has a demand for a computer program for improving processing performance of a database by a DBMS.

### RELATED ART LITERATURE

### Patent Document

(Patent Document 1) U.S. Pat. No. 6,775,682

(Patent Document 2) U.S. Pat. No. 9,886,474

### SUMMARY OF THE INVENTION

The present disclosure is conceived in response to the background art, and has been made in an effort to provide a computer program for managing a database.

In order to solve the foregoing objects, an exemplary embodiment of the present disclosure discloses a computer program executable by one or more processors and stored in a computer readable medium. The computer program causes the one or more processors to perform operations for database management when executed by the one or more processors, the operations including: generating a sorted table by sorting a table including one or more records based on at least one column; identifying a current key corresponding to each of one or more rows included in the sorted table; sequentially recording a record corresponding to each of the one or more rows in a data structure based on a result of a comparison between the current key corresponding to each of the one or more rows and a previous key; and generating an integrated result value for a record recorded in the data structure and recording the generated integrated result value in an output table.

Alternatively, the data structure may include one or more levels, and a record of the sorted table may be recorded in each of the one or more levels.

Alternatively, the current key may be generated based on at least one column included in the sorted table, and include at least one of a reference key and a dependent key except for the reference key.

Alternatively, the sequentially recording of the record corresponding to each of the one or more rows in the data structure based on the result of the comparison between the current key corresponding to each of the one or more rows and the previous key may include determining a level at which a record of the sorted table is to be recorded in the data structure based on the result of the comparison between the current key and the previous key.

Alternatively, the sequentially recording of the record corresponding to each of the one or more rows in the data structure based on the result of the comparison between the current key corresponding to each of the one or more rows and the previous key may include recording a record of a row corresponding to the current key at the lowest level of the data structure when the previous key does not exist.

Alternatively, the sequentially recording of the record corresponding to each of the one or more rows in the data structure based on the result of the comparison between the current key corresponding to each of the one or more rows and the previous key may include: recording a record corresponding to the current key at the same level as that of the previous key in the data structure when the current key is the same as the previous key as the result of the comparison; and recording a record corresponding to the current key at a level different from that of the previous key in the data structure when the current key is different from the previous key as the result of the comparison.

Alternatively, the sequentially recording of the record corresponding to each of the one or more rows in the data structure based on the result of the comparison between the current key corresponding to each of the one or more rows and the previous key may include: recording a record of a row corresponding to the current key at the lowest level of the data structure when the current key is the same as the previous key as the result of the comparison; and recording a record pre-recorded at the lowest level of the data structure by changing the level of the pre-recorded record to a first level that is a higher level when the current key is different from the previous key as the result of the comparison, and recording a record of a row corresponding to the current key at the lowest level.

Alternatively, the recording of the record pre-recorded at the lowest level of the data structure by changing the level of the pre-recorded record to the first level that is the higher level when the current key is different from the previous key as the result of the comparison, and the recording of the record of the row corresponding to the current key at the lowest level may include recording the record recorded at the first level by changing the level of the record to a second level that is a higher level than the first level when an additional record is recorded at the first level.

Alternatively, the recording of the record pre-recorded at the lowest level of the data structure by changing the level of the pre-recorded record to the first level that is the higher level when the current key is different from the previous key as the result of the comparison, and the recording of the record of the row corresponding to the current key at the lowest level may include: determining whether a reference key of the current key matches a reference key of the previous key; and recording the record recorded at the first level by changing the level of the record to the second level that is the higher level than the first level when the reference key of the current key is different from the reference key of the previous key.

Alternatively, the sequentially recording of the record corresponding to each of the one or more rows in the data structure based on the result of the comparison between the current key corresponding to each of the one or more rows and the previous key may include performing additional sorting on a record recorded at a different level when the level of the record located at each of the one or more levels is changed to the different level.

Alternatively, the generating of the integrated result value for the record recorded in the data structure and the recording of the generated integrated result value in the output table may include: comparing the current key with the previous key; and generating an integrated result value for a record recorded at a level corresponding to the previous key in the data structure and recording the generated integrated result value in the output table when the current key is different from the previous key.

Alternatively, the generating of the integrated result value for the record recorded in the data structure and the recording of the generated integrated result value in the output table may include: comparing the current key with the previous key; determining whether a reference key of the current key matches a reference key of the previous key; and generating an integrated result value for a record at a higher level of the data structure and recording the generated integrated result value in the output table when the reference key of the current key is different from the reference key of the previous key.

Alternatively, the generating of the integrated result value for the record recorded in the data structure and the recording of the generated integrated result value in the output table may include: identifying a change in a level of the record recorded in the data structure; and generating an integrated result value for the record of which the level is changed in response to the change in the level and recording the generated integrated result value in the output table.

Alternatively, the integrated result value may be calculated based on the SQL received from a client, and may be a record value calculated for each level in response to a current key of each of the one or more rows.

Another exemplary embodiment of the present disclosure discloses a server for managing a database. The server may include a processor including one or more cores, a storage unit storing program codes executable by the processor, and a network unit transceiving data with a client, and the processor may generate a sorted table by sorting a table including one or more records based on at least one column, identify a current key corresponding to each of one or more rows included in the sorted table; sequentially record a record corresponding to each of the one or more rows in a data structure based on a result of a comparison between the current key corresponding to each of the one or more rows and a previous key, and generate an integrated result value for a record recorded in the data structure and record the generated integrated result value in an output table.

Another exemplary embodiment of the present disclosure discloses a method of managing a database. The method may include: generating a sorted table by sorting a table including one or more records based on at least one column; identifying a current key corresponding to each of one or more rows included in the sorted table; sequentially recording a record corresponding to each of the one or more rows in a data structure based on a result of a comparison between the current key corresponding to each of the one or more rows and a previous key; and generating an integrated result value for a record recorded in the data structure and recording the generated integrated result value in an output table.

The present disclosure may provide a computer program for improving database processing performance in a database system.

### BRIEF DESCRIPTION OF THE DRAWINGS

Various aspects are described with reference to the drawings, and herein, like reference numerals are generally used to designate like constituent elements. In the exemplary embodiment below, for the purpose of description, a plurality of specific and detailed matters is suggested in order to provide general understanding of one or more aspects. However, it is apparent that the aspect(s) may be carried out without the specific and detailed matters.

FIG. 1 is a schematic diagram illustrating a database system according to an exemplary embodiment of the present disclosure.

FIG. 2 is a block diagram illustrating a computing device according to an exemplary embodiment of the present disclosure.

FIG. 3 is a flowchart illustrating an example of a method of managing a database according to an exemplary embodiment of the present disclosure.

FIG. 4 is a diagram illustrating an example of a method of generating a sorted table by sorting a table according to an exemplary embodiment of the present disclosure.

FIG. 5 is a diagram illustrating an example of a method of generating an integrated result value and recording the generated integrated result value in an output table according to an exemplary embodiment of the present disclosure.

FIG. 6 is a diagram illustrating an example of a method of generating an integrated result value and recording the generated integrated result value in an output table according to an exemplary embodiment of the present disclosure.

FIG. 7 is a diagram illustrating an example of a method of generating an integrated result value and recording the generated integrated result value in an output table according to an exemplary embodiment of the present disclosure.

FIG. 8 is a diagram illustrating a means for performing a database management according to an exemplary embodiment of the present disclosure.

FIG. 9 is a simple and general schematic diagram illustrating an example of a computing environment in which the exemplary embodiments of the present disclosure are implementable.

### DETAILED DESCRIPTION

Hereinafter, various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and the computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as Internet, through data and/or a signal from one component interacting with another component in a local system and a distributed system) having one or more data packets.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases.

Further, a term “and/or” used in the present specification shall be understood to designate and include all of the possible combinations of one or more items among the listed relevant items.

A term “include” and/or “including” shall be understood as meaning that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations has been generally described above in the functional aspects thereof. Whether the functionality is implemented by hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

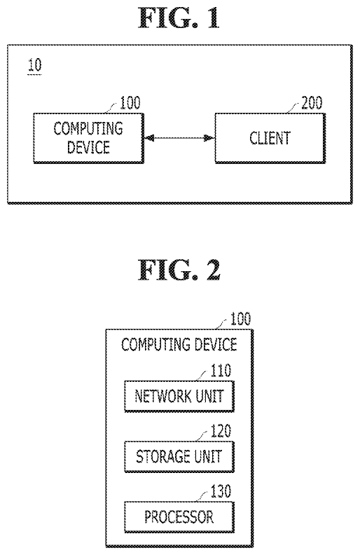

FIG. 1 is a schematic diagram illustrating a database system according to an exemplary embodiment of the present disclosure.

As illustrated in FIG. 1, a database system 10 may include a computing device 100, a network, and a client 200.

The client 200 may mean a predetermined form of node(s) in a system having a mechanism for communicating with the database computing device 100. For example, the client may include a Personal Computer (PC), a laptop computer, a workstation, a terminal, and/or a predetermined electronic device having network accessibility. Further, the client may also include a predetermined server implemented by at least one of an agent, an Application Programming Interface (API), and plug-in.

According to the exemplary embodiment of the present disclosure, operations of the computing device 100 which are to be described below may be performed according to a query issued from the client.

The computing device 100 may include a predetermined type of computer system or computer device, for example, a microprocessor, a main frame computer, a digital single processor, a portable device, and a device controller. The computing device 100 may include a database management system (DBMS) and/or a persistent storage medium. The computing device 100 in the present specification may mean a predetermined form of nodes in the database system 10.

FIG. 2 is a block diagram illustrating the computing device according to the exemplary embodiment of the present disclosure.

As illustrated in FIG. 2, the computing device 100 may include a network unit 110, a storage unit 120, and a processor 130. The foregoing components are illustrative, and the scope of the contents of the present disclosure is not limited to the foregoing components. That is, additional components may be included or some of the foregoing components may be omitted according to an implementation aspect for the exemplary embodiments of the contents of the present disclosure.

According to the exemplary embodiment of the present disclosure, the computing device 100 may include the network unit 110 transceiving data with the client 200. For example, when the network unit 110 is located outside the computing device 100, the network unit 110 may receive an output table generated by performing an operation based on an SQL that is received for a specific table from the computing device 100. The network unit 110 may receive an input from the client 200. For example, the network unit 110 may receive a request related to storage, change, and inquiry of data, and build, change, and inquiry of an index from the client 200. In addition, the network unit 110 may allow information transfer between the computing device 100 and the client 200 by a scheme of calling a procedure to the computing device 100.

The network unit 110 according to the exemplary embodiment of the present disclosure may use various wired communication systems, such as a public switched telephone network (PSTN), an x digital subscriber line (xDSL), a rate adaptive DSL (RADSL), a multi rate DSL (MDSL), a very high speed DSL (VDSL), a universal asymmetric DSL (UADSL), a high bit rate DSL (HDSL), and a local area network (LAN).

The network unit 110 presented in the present specification may use various wireless communication systems, such as code division multi access (CDMA), time division multi access (TDMA), frequency division multi access (FDMA), orthogonal frequency division multi access (OFDMA), single carrier-FDMA (SC-FDMA), and other systems. As an additional exemplary embodiment, the network unit 110 presented in the present specification may also include a database link (dblink), and thus, the computing device 100 may communicate through the database link and fetch data from another database server. The technologies described in the present specification may also be used in other networks, as well as the foregoing networks.

According to the exemplary embodiment of the present disclosure, the storage unit 120 may include a persistent storage medium and a memory.

The persistent storage medium may mean a non-volatile storage medium, such as a storage device based on a flash memory and/or a battery-backup memory, which is capable of continuously storing predetermined data, as well as a magnetic disk, an optical disk, and a magneto-optical storage device. The persistent storage medium may communicate with the processor 130 and the memory of the computing device 100 through various communication means. In an additional exemplary embodiment, the persistent storage medium may also be located outside the computing device 100 and communicate with the computing device 100.

The memory is a main storage device, such as a random access memory (RAM) including a dynamic RAM (DRAM) and a static RAM (SRAM), to which a processor directly accesses, and may mean a volatile storage device, in which when power is cut, stored information is momentarily erased, but the memory is not limited thereto. The memory may be operated by the processor 130. The memory may temporarily store a data table including a data value. The data table may include a data value, and in the exemplary embodiment of the present disclosure, the data value of the data table may be recorded in the persistent storage medium from the memory. In an additional aspect, the memory may include a buffer cache, and data may be stored in a data block of the buffer cache. The data stored in the buffer cache may be recorded in the persistent storage medium by a background process.

According to the exemplary embodiment of the present disclosure, the processor 130 generally controls a general operation of the computing device 100. The processor 130 may perform operations for improving database management performance by processing a signal, data, information, and the like through the foregoing constituent elements or driving an application program stored in the storage unit 120.

According to the exemplary embodiment of the present disclosure, the processor 130 may generate a sorted table by sorting a table including one or more records based on at least one column. The sorting for the table may mean systematically organizing one or more records included in the table. More particularly, the sorting for the table may mean performing merging and/or aligning one or more records included in the table so as to efficiently integrate the records through a search (or indexing) for one or more records. That is, when the sorting is performed on the table, the records may be aligned in a defined order.

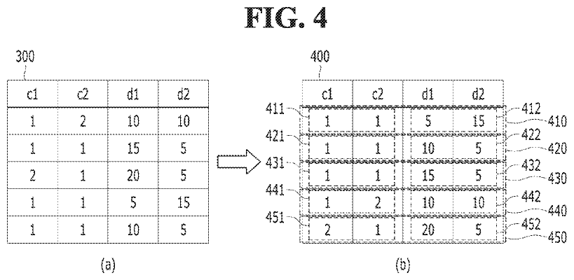

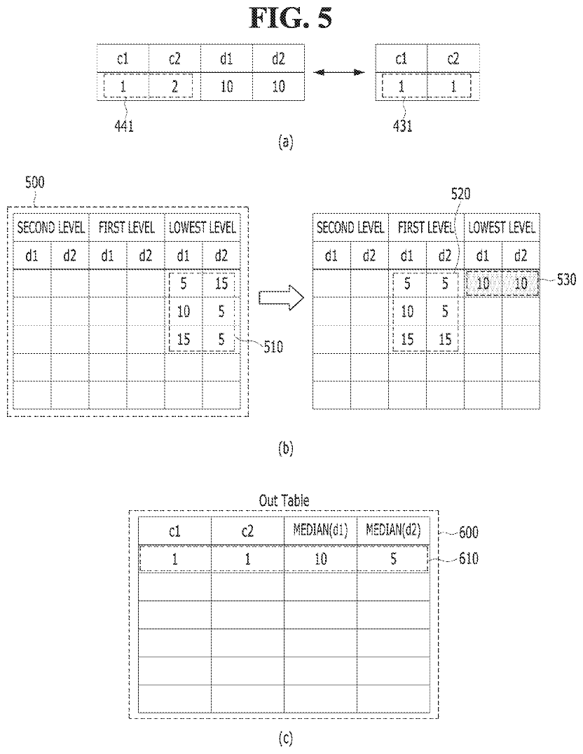

For example, the processor 130 may sort a table 300 illustrated in (a) of FIG. 4, and generate a sorted table 400 illustrated in (b) of FIG. 4. Particularly, when the sorting is performed on the table 300 illustrated in (a) of FIG. 4, the processor 130 may align the records based on two columns (that is, “c1” and “c2”) of the corresponding table in an ascending order and generate the sorted table 400 as illustrated in (b) of FIG. 4. Further, in the sorted table 400 illustrated in (b) of FIG. 4, when columns “c1” and “c2” have the same records, the processor 130 may also generate the sorted table by merging the records corresponding to the respective rows. The particular description of the sorting method for the table is simply illustrative, and the present disclosure is not limited thereto.

According to the exemplary embodiment of the present disclosure, the processor 130 may identify a current key corresponding to each of the one or more rows included in the sorted table. The key may be a reference for grouping records. For example, the key may be a value recorded in a column for grouping the records. For example, in (a) of FIG. 4, columns C1 and C2 may be the columns in which the values that may be the references for grouping the records are recorded, and the values recorded in the columns may be the keys. The database of the present disclosure may be formed in a tabular format, and the table may include columns and rows. The record in the present disclosure may mean data of each column included in the row.

The key in the present disclosure may be a record which is a reference for aligning the respective rows among the records and is recorded in a column. The current key may mean a record serving as a reference for calculating an output value based on each level in the table. Further, the current key may be generated based on one column included in the table, and include at least one of a reference key and a dependent key except for the reference key.

For example, in the case of the sorted table 400 illustrated in FIG. 4, the records included in column c1 based on each row may be the current keys corresponding to each row, and the records included in columns c1 and c2 based on each row may also be the current keys corresponding to each row. That is, according to the number of references for calculating an output value for each group in the table, the processor 130 may identify the records corresponding to a specific column as the current keys. In addition, when the records for two columns “c1” and “c2” are the current keys corresponding to each row, the records located in the column corresponding to “c1” may be the reference keys, and the records located in the column corresponding to “c2” may be the dependent keys. That is, when the keys consist of the records of the several columns, the rows may be grouped according to the number of components of the keys. For example, in a grouping operation in which c1 and c2 are the components of the key, the grouping in which only c is the component of the key has a higher level than that of the grouping in which both c1 and c2 are the components of the key, and in this case, only c1 is the component of the key, so that c1 may be the reference key and c2 may be the dependent key. The particular descriptions for the number of columns corresponding to the current key, and the reference key and the dependent key are simply illustrative, and the present disclosure is not limited thereto.

In addition, the number of keys as a reference for grouping records in this disclosure is not limited. That is, the records included in the additional columns may be added as a key for grouping the records by level.

More particularly, referring to FIG. 4, for example, in the case of outputting an output value for each detailed level for a column corresponding to two components “c1” and “c2, the processor 130 may identify a current key corresponding to a first row 410 as “1, 1” 411, identify a current key corresponding to a second row 420 as “1, 1” 421, identify a current key corresponding to a third row 430 as “1, 1” 431, identify a current key corresponding to a fourth row 440 as “1, 2” 441, and identify a current key corresponding to a fifth row 450 as “2, 1” 451. The particular description for the current key corresponding to each of the one or more rows included in the table is simply illustrative, and the present disclosure is not limited thereto.

That is, the processor 130 may generate a sorted table by performing the sorting based on one or more columns so that one or more records included in a specific table may be efficiently searched (or indexed) and grouped.

According to the exemplary embodiment of the present disclosure, the processor 130 may sequentially record the records of the sorted table in a data structure based on each row. The processor 130 may sequentially record the records of the sorted table in the data structure based on a result of a comparison between a current key and a previous key. The data structure may be previously built in order to obtain an integrated result value of a record for each detailed level for one or more records of the table. The data structure may occupy a partial space of the storage unit 120. The data structure may be stored in, for example, a main memory, or a persistent storage medium. Further, the data structure may include one or more levels in which the records of the sorted table are recorded, and the one or more levels may be divided based on one or more columns. More particularly, the processor 130 may sequentially process the records in a defined order (for example, an alignment order of the rows of the sorted table) of the sorted table. When a first record (that is, a record corresponding to the first row) is recorded in the data structure by the processor 130, a first current key for the first record may be maintained in the memory. Then, when a second record (that is, a record corresponding to the second row) is recorded in the data structure by the processor 130, a second current key for the second record may be maintained. In this case, the processor 130 may compare the second current key with the first current key. That is, when the second record corresponding to the second current key is recorded in the data structure, the first current key may be treated as a previous key. In addition, the processor 130 may sequentially record the records of the sorted table in the data structure based on the result of the comparison.

According to the exemplary embodiment of the present disclosure, the processor 130 may determine a level at which the record of the sorted table is to be recorded in the data structure based on the result of the comparison between the current key and the previous key. Particularly, when the current key and the previous key are the same, the processor 130 may record the record corresponding to the current key at the same level as the level at which the record corresponding to the previous key is recorded in the data structure.

For example, when the first current key corresponding to the first row of the sorted table is “1”, the first record is “5”, the first record is recorded at a first level of the data structure, and the second current key corresponding to the second row is “1”, and the second record is “10”, the processor 130 may identify that the first current key is the same as the second current key and record “10” that is the second record at the first level that is the same level as the level at which the first record is recorded. The description for the particular numerical values of the current key and the record is simply illustrative, and the present disclosure is not limited thereto.

When there exists no previous key, the processor 130 may record the record of the row corresponding to the current key at the lowest level of the data structure. Particularly, when the first row (that is, the row located at the uppermost end) of the sorted table is recorded in the data structure, there may be no previous key which is to be compared with the current key corresponding to the first row because there is no current key maintained in the memory. In this case, the processor 130 may record the record of the first row in the lowest level of the data structure.

According to another exemplary embodiment of the present disclosure, when the current key is the same as the previous key, the processor 130 may record a record of a row corresponding to the current key at the lowest level of the data structure.

For example, referring to FIGS. 4 and 5, in the case of the sorted table 400 illustrated in (b) of FIG. 4, the processor 130 may identify the current keys (that is, the first current key 411, the second current key 421, the third current key 431, the fourth current key 441, and the fifth current key 451) of the first row 410 to the fifth row 450, and sequentially record a first record 412 to a fifth record 452 in a data structure 500 based on the identified current keys. Particularly, when the processor 130 records the first record 412 of the first row 410 in the data structure 500, the first current key 411 may be maintained in the memory. Then, when the second record 422 of the second row 420 is recorded in the data structure 500, the processor 130 may compare the second current key 421 with the first key 411 maintained in the memory. In this case, the second current key 421 is the same as the first current key 411, so that the processor 130 may record the second record 422 at the lowest level that is the same level as the level of the first record 412 in the data structure 500. That is, when the second record 422 is recorded in the data structure, the first current key 411 corresponding to the first record 412 that is recorded before the second record 422 may be treated as a previous key. Further, when a third record 432 of the third row 430 is recorded in the data structure 500, the processor 130 may compare the third current key 431 with the second current key 421 that is the previous key. In this case, the third current key 431 is the same as the second current key 421 that is the previous key, so that the processor 130 may also record the third record at the lowest level that is the same level as the level of the second record (or the first record) in the data structure 500. That is, when the records of the first row, the second row, and the third row are sequentially recorded in the data structure, each current key is the same as the previous key of each current key, so that the first record, the second record, and the third record may be recorded 510 at the lowest level of the data structure as illustrated in (b) of FIG. 5. The descriptions for the particular numerical values of the rows, the current keys, and the records of the sorted table are simply illustrative, and the present disclosure is not limited thereto.

According to the exemplary embodiment of the present disclosure, when the current key is different from the previous key, the processor 130 may record a record corresponding to the current key at a level different from a level of the previous key in the data structure.

For example, when the second current key corresponding to the second row of the sorted table is “1”, the second record is “10”, the second record is recorded at the first level of the data structure, the third current key corresponding to the third row is “2”, and the third record is “5”, the processor 130 may identify that the second current key is different from the third current key, and record “10” that is the second record at a level (for example, a second level or the lowest level) different from the level at which the third record is recorded. The description for the particular numerical values of the current key and the record is simply illustrative, and the present disclosure is not limited thereto.

According to another exemplary embodiment of the present disclosure, when the current key is different from the previous key, the processor 130 may record a record of a row corresponding to the current key at the lowest level of the data structure.

Particularly, when the current key is different from the previous key, the processor 130 may record the record that is previously recorded at the lowest level of the data structure by changing the lowest level of the record to the first level that is a higher level, and record a record of a row corresponding to the current key at the lowest level. Further, when the current key is different from the previous key, the processor 130 may change the lowest level of the data structure to the first level, generate the new lowest level, and record a record of a row corresponding to the current key.

For example, referring to FIGS. 4 and 5, in the case of the sorted table illustrated in (b) of FIG. 4, as described above, when the records of the first row 410, the second row 420, and the third row 430 are sequentially recorded in the data structure 500, the records may be recorded 510 at the same lowest level in the data structure 500 because each current key is the same as the previous key of each current key. That is, the third current key 431 of the third row 430 may be maintained in the current memory.

In this situation, when a fourth record 442 of the fourth row 440 is recorded in the data structure 500, the processor 130 may compare the fourth current key 441 with the third current key 431 that is the previous key. In this case, as illustrated in (a) of FIG. 5, the fourth current key 441 is the same as the third current key 431 that is the previous key, the processor 130 may record 520 a record 510 that is previously recorded at the lowest level by changing the lowest level to the first level that is a higher level, and record 530 the fourth record 442 at the lowest level of the data structure as illustrated in (b) of FIG. 5. The descriptions for the particular numerical values of the rows, the current keys, and the records of the sorted table are simply illustrative, and the present disclosure is not limited thereto.

That is, when the processor 130 sequentially records the records for one or more rows of the sorted table in the data structure, the processor 130 may determine to record the records at a specific level among one or more levels included in the data structure based on a result of the comparison between the current key corresponding to each record and the previous key.

Accordingly, it is possible to more easily perform a classification based on each level according to a current key of each of the one or more rows included in the sorted table.

According to the exemplary embodiment of the present disclosure, the processor 130 may perform additional sorting based on the change in the level of one or more records recorded in the data structure. Particularly, when the level of the record located in each of the one or more levels of the data structure is changed to a different level, the processor 130 may perform additional sorting on the record recorded at the different level.

For example, referring to FIGS. 4 and 5, the fourth current key 441 is different from the third current key 431 that is the previous key, so that the first record 412, the second record 422, and the third record 432 recorded 510 at the lowest level may be changed to the first level and recorded by the processor 130. The processor 130 may identify that the records recorded 510 at the lowest level are changed to the different level (that is, the first level) and perform the additional sorting on the record recorded at the different level. That is, the records 510 recorded at the lowest level may be changed to the first level and recorded, and simultaneously, the records may be aligned in an ascending order through the additional sorting and recorded 520 by the processor 130 as illustrated in (b) of FIG. 5. That is, when the additional record is recorded at a specific level among the one or more levels of the data structure, the processor 130 may perform the additional sorting on the record recorded at the specific level. The alignment of the records through the additional sorting is simply illustrative, and the present disclosure is not limited thereto. For example, the additional sorting may further include various sorting, such as alignment based on distinction, alignment in a descending order, selective alignment, redundancy removal, and insertion alignment, but the present disclosure is not limited thereto.

According to the exemplary embodiment of the present disclosure, when the additional record is recorded at the first level of the data structure, the processor 130 may record the record that is previously recorded at the first level by changing the level of the record to a second level that is a higher level than the first level.

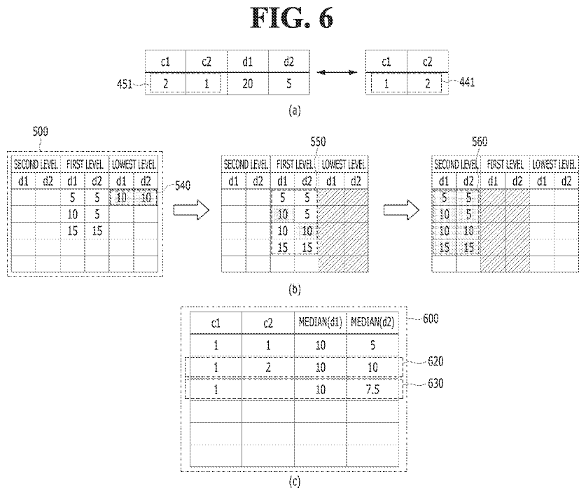

Particularly, for example, referring to FIGS. 4 to 6, as described above, when the first record 412 to the fourth record 442 of the sorted table 400 are sequentially recorded in the data structure 500, the first record 412 to the third record 432 may be recorded 520 at the first level in the data structure 500, and the fourth record 530 may be recorded at the lowest level as illustrated in (b) of FIG. 5. That is, a current key of the fourth row 440 may be maintained in the current memory. In this situation, when a fifth record 452 of the fifth row 450 is recorded in the data structure 500, the processor 130 may compare the fifth current key 451 with the fourth current key 441 that is the previous key. In this case, as illustrated in (a) of FIG. 6, the fifth current key 451 is different from the fourth current key 441, so that the processor 130 may change the record 540 recorded at the lowest level to the first level and record 550 the record as illustrated in (b) of FIG. 6. When the separate record (that is, the fourth record) 540 is added to the first level in a situation where the records (that is, the first record to the third record) already exist at the first level of the data structure, the processor 130 may change the records (that is, the first record and the fourth record) recorded 550 at the first level to the second level that is a higher level than the first level and record 560 the records. The descriptions for the particular numerical values of the rows, the current keys, and the records of the sorted table are simply illustrative, and the present disclosure is not limited thereto.

According to another exemplary embodiment of the present disclosure, the processor 130 may change the record recorded at the first level of the data structure to the second level that is a higher level than the first level and record the record based on whether a reference key of the current key matches a reference key of the previous key. Particularly, when a reference key of the current key is different from a reference key of the previous key, the processor 130 may change the record previously recorded at the first level to the second level that is a higher level than the first level and record the record.

For example, referring to FIGS. 4 to 6, as described above, when the first record 412 to the fourth record 442 of the sorted table 400 are sequentially recorded in the data structure 500, the first record 412 to the third record 432 may be recorded 520 at the first level in the data structure 500, and the fourth record 530 may be recorded at the lowest level as illustrated in (b) of FIG. 5. That is, the current key of the fourth row 440 may be maintained in the current memory. In this situation, when the fifth record 452 of the fifth row 450 is recorded in the data structure 500, the processor 130 may compare the fifth current key 451 with the fourth key 441 that is the previous key. Particularly, whether a reference key of the fifth current key matches a reference key of the fourth current key may be determined. In this case, the record value of column c1 of the sorted table may be the reference key, and the record value of column c2 may be the dependent key. That is, the reference key of the fifth current key may be “2” and the reference key of the fourth current key 441 may be “1”, so that the reference keys of the fifth current key and the fourth current key may be different. As described above, when the reference key of the fifth current key is different from the reference key of the fourth current key 441, the processor 130 may change the records (that is, the first record and the fourth record) recorded 550 at the first level to the second level that is a higher level than the first level and record 560 the records as illustrated in (b) of FIG. 6.

The processor 130 may read the records recorded at the current level in the space of the storage unit 120 allocated to the data structure, record the records in a space allocated to a higher level, and remove the records recorded at the current level. In addition, the processor 130 may record the records by changing the levels of the records to a higher level by a method of changing the space allocated for the records recorded at the current level in the data structure to a higher level, and changing the level allocated to the corresponding storage location in the state where physical storage locations of the records are maintained. The descriptions for the particular numerical values of the rows, the current key, the reference key, and the records of the sorted table are simply illustrative, and the present disclosure is not limited thereto.

According to the exemplary embodiment of the present disclosure, when there exists no additional row to be recorded in the data structure, the processor 130 may record the record recorded in the data structure by changing the level of the record to a higher level. Particularly, when there exists no additional row to be recorded in the data structure, the processor 130 may sequentially change the record recorded at one or more levels up to the highest level and record the record.

According to the exemplary embodiment of the present disclosure, the processor 130 may output an integrated result value for the record recorded in the data structure and record the output integrated result value in an output table. The integrated result value may be calculated based on a Structured Query Language (SQL) received from the client 200, and may be calculated based on the record included in one or more rows. For example, the integrated result value may be calculated based on the record included in each group for the one or more grouped rows. For example, the integrated result value may be a record value calculated for each level in response to a current key of each of the one or more rows. In this case, the level may mean one or more groups. That is, the integrated result value may mean a total value for each group for the number of cases corresponding to the number of records recorded in the table.

Particularly, the processor 130 may compare the current key with the previous key. Further, when the current key is different from the previous key, the processor 130 may generate an integrated result value for a record recorded at a level corresponding to the previous key in the data structure and record the generated integrated result value in the output table.

For example, referring to FIGS. 4 and 5, as described above, when the first record 412 to the third record 432 of the sorted table 400 are sequentially recorded in the data structure 500, the first record 412 to the third record 432 may be recorded 510 at the lowest level of the data structure 500 as illustrated in (b) of FIG. 5. In this situation, when the fourth record 442 of the fourth row 440 that is a next row in the sorted table 400 is recorded in the data structure, the processor 130 may compare the fourth current key 441 with the third current key 431 that is the previous key. As illustrated in (a) of FIG. 5, the processor 130 may determine that the fourth current key 441 is different from the third current key 431, and generate an integrated result value for the records 510 (that is, the first record to the third record) of the lowest level that is the level corresponding to the previous key and record 610 the generated integrated result value in an output table 600 as illustrated in (c) of FIG. 5. In this case, the integrated result value may be the result value output in response to the SQL of the client, and the integrated result value illustrated in FIG. 5 is the value obtained by calculating medians of the records according to each level. That is, “10.5” that is a median value of the records 510 included in the lowest level that is the level corresponding to the previous key may be output. In the foregoing example, the case where the median of the records is generated as the integrated result value is described, but it will be apparent to those skilled in the art that the present disclosure may further include various functions, such as Sum, Distinct, Count, Max, and Avg. That is, the integrated result value of the present disclosure may be integrated through various functions according to an analysis purpose of the record of the client.

Hereinafter, the integrated result value described with reference to FIGS. 4 to 7 may be integrated through various functions according to the purpose of the analysis of the record of the client, and it will be apparent to those skilled in the art that the integrated result value is not limited to a specific function.

For another example, referring to FIGS. 4 to 6, as described above, when the first record 412 to the fourth record 442 of the sorted table 400 are sequentially recorded in the data structure 500, the first record 412 to the third record 432 may be recorded 520 at the first level in the data structure 500, and the fourth record 530 may be recorded at the lowest level as illustrated in (b) of FIG. 5. That is, a current key of the fourth row 440 may be maintained in the current memory. In this situation, when the fifth record 452 of the fifth row 450 is recorded in the data structure 500, the processor 130 may compare the fifth current key 451 with the fourth key 441 that is the previous key. As illustrated in (a) of FIG. 6, the processor 130 may determine that the fifth current key 451 is different from the fourth current key 441, and generate an integrated result value for the records 540 (that is, the first record to the third record) of the lowest level that is the level corresponding to the previous key and record 620 the generated integrated result value in the output table 600 as illustrated in (c) of FIG. 6. In this case, only the record corresponding to one row is recorded at the lowest level, so that “10, 10” may be generated as the integrated result value and generated in the output table 600. The description of the particular numerical value of the integrated result value is simply illustrative, and the present disclosure is not limited thereto.

According to the exemplary embodiment of the present disclosure, the processor 130 may generate an integrated result value for the record of the data structure based on whether the reference key of the current key matches the reference key of the previous key, and record the generated integrated result value in the output table. The record of the higher level may mean the records of all of the levels except for the record of the lowest level. More particularly, when the reference key of the current key is different from the reference key of the previous key, the processor 130 may generate an integrated result value for the record of the higher level and record the generated integrated result value in the output table.

For example, referring to FIGS. 4 to 6, as described above, when the first record 412 to the fifth record 452 of the sorted table 400 are sequentially recorded in the data structure 500, the first record 412 to the fourth record 442 may be recorded 520 at the first level of the data structure 500 as illustrated in (b) of FIG. 6. That is, a current key of the fourth row 440 may be maintained in the current memory. In this situation, when the fifth record 452 of the fifth row 450 is recorded in the data structure 500, the processor 130 may compare the fifth current key 451 with the fourth key 441 that is the previous key. Particularly, the processor 130 may determine whether a reference key of the fifth current key matches a reference key of the fourth current key. In this case, the record value of column c1 of the sorted table may be the reference key, and the record value of column c2 may be the dependent key. That is, the reference key of the fifth current key may be “2” and the reference key of the fourth current key 441 may be “1”, so that the reference keys of the fifth current key and the fourth current key may be different. As described above, when the reference key of the fifth current key is different from the reference key of the fourth current key 441, the processor 130 may generate an integrated result value for the record 550 recorded at all of the levels except for the record of the lowest level and record 630 the generated integrated result value in the output table 600 as illustrated in (c) of FIG. 6. In this case, d1 of the record 550 recorded at all of the levels is “5”, “10”, “10”, and “15’ and d2 is “5”, “5”, “10”, and “15”, so that the median values “10” and “7.5” of the respective records may be generated as the integrated result values and recorded 630 in the output table 600. The description of the particular numerical value of the integrated result value is simply illustrative, and the present disclosure is not limited thereto.

The processor 130 may output the integrated result value based on whether the reference key of the current key matches the reference key of the previous key. The feature that the reference key of the current key is different from the reference key of the previous key may mean that the level of the current record is different from the level of the previous record. That is, the processor 130 may identify a section in which the levels are different to generate an integrated result value for each specific level.

According to another exemplary embodiment of the present disclosure, the processor 130 may generate an integrated result value based on the change in the level of the record recorded in the data structure and record the generated integrated result value in the output table. More particularly, the processor 130 may identify the change in the level of the record recorded in the data structure. Further, the processor 130 may generate an integrated result value for the record, of which the level is changed in response to the change in the level, and record the generated integrated result value in the output table.

For example, referring to FIG. 5, as described above, when the fourth record of the fourth row 440 is recorded in the data structure 500, the fourth current key 441 is different from the third current key 431 that is the previous key, so that the records (that is, the first record to the third record) 510 recorded at the lowest level are changed to the first level and recorded. That is, the processor 130 may identify that the records 510 located at the lowest level are changed to the first level and recorded 520, and generate an integrated result value of the records of which the levels are changed to the first level and record 610 the generated integrated result value in the output table 600. In this case, d1 of the record 520 of which the level is changed to the first level is “5”, 10”, and “10”, and d2 is “5”, “5”, and “10”, so that “10” and “5” that are the median values of the respective records may be generated as the integrated result values and recorded 610 in the output table 600. The description of the particular numerical value of the integrated result value is simply illustrative, and the present disclosure is not limited thereto.

For another example, referring to FIG. 6, as described above, when the fifth record 452 of the fifth row 450 is recorded in the data structure 500, the fifth current key 451 is different from the fourth current key 441 that is the previous key, so that the records 540 (that is, the fourth record) recorded at the lowest level may be changed to the first level and recorded. That is, the processor 130 may identify that the records 540 located at the lowest level are changed to the first level and recorded 550, and generate an integrated result value of the records (that is, the fourth record) which are changed to the first level and record 620 the generated integrated result value in the output table 600. In this case, d1 of the record 520 of which the level is changed to the first level is “10” and d2 is “10”, so that “10” and “10” that are the median values of the respective records may be generated as the integrated result values and recorded 620 in the output table 600. The description of the particular numerical value of the integrated result value is simply illustrative, and the present disclosure is not limited thereto.

For another example, referring to FIG. 6, as described above, when a separate record (that is, the fourth record) 540 is added to the first level in a situation where the records (that is, the first record to the third record) already exist at the first level of the data structure, the records (that is, the first record and the fourth record) 550 recorded at the first level may be changed to the second level that is the higher level than the first level and recorded 560. In this case, the processor 130 may generate an integrated result value for the records 550 recorded at the first level in response to the case where the records 550 recorded at the first level are changed to the second level and recorded, and record 630 the generated integrated result value in the output table 600. More particularly, when a current key having a different value from that of the previous key is read, the processor 130 may read the records 550 recorded at the first level and generate an integrated result value for the records 550 recorded at the first level and record 630 the generated integrated result value in the output table, and change the records 550 recorded at the first level to the second level and record the records 550. When the current key value that is different from the previous key value is read, the processor 130 may perform an operation for identifying a level at which the record is currently being recorded in order to change the record recorded at the level, at which the record is currently being recorded, to a higher level in the data structure and record the record, reading the records included in the identified level, at which the record is currently being recorded, generating an integrated result, changing the records included in the level, at which the record is currently being recorded, to a higher level, and recording the records. In order to change the records included at the level, at which the record is currently being recorded, to a higher level and record the records, the processor 130 may also record the records included in the level, at which the record is currently being recorded, in a storage space allocated to a higher level, and allocate a storage space allocated to the level, at which the record is currently being recorded, to a high level.

In this case, d1 of the record 520 of which the level is changed to the second level is “5”, “10”, “10’, and “15”, and d2 is “5”, “5”, 10”, and “15”, so that “10” and “7.5” that are the median values of the respective records may be generated as the integrated result values and recorded 630 in the output table 600. The description of the particular numerical value of the integrated result value is simply illustrative, and the present disclosure is not limited thereto.

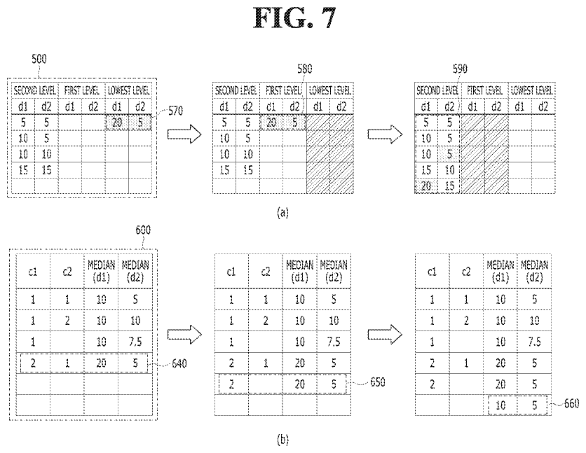

For another example, referring to FIGS. 4 to 7, when the sorted table 400 includes five rows and the records of the first row 410 to the fourth row 440 are sequentially recorded in the data structure 500, the first record 412 to the fourth record 442 may be recorded 560 by the operations of the processor 130 as illustrated in (b) of FIG. 6. In this situation, when the fifth record 452 of the fifth row 450 is recorded in the data structure, as illustrated in (b) of FIG. 6, the fifth current key 451 is different from the fourth current key 441 that is the previous key, so that the fifth record 452 may be recorded 570 at the lowest level. There exists no record to be additionally recorded in the data structure 500, so that as illustrated in (a) of FIG. 7, the record 570 (that is, the fifth record) recorded at the lowest level may be changed to the first level and recorded 580. In this case, the processor 130 may generate an integrated result value for the record 570 recorded at the lowest level in response to the case where the record 570 recorded at the lowest level is changed to the first level and recorded 580 and record 640 the generated integrated result value in the output table 600 as illustrated in (b) of FIG. 7. In this case, d1 of the record 570 of which the level is changed to the first level is “20” and d2 is “5”, so that “20” and “5” that are the median values of the respective records may be generated as the integrated result values and recorded 640 in the output table 600. The description of the particular numerical value of the integrated result value is simply illustrative, and the present disclosure is not limited thereto.

Thereafter, there exists no record to be additionally recorded, so that the processor 130 may change the record 580 (that is, the fifth record) recorded at the first level to the second level and record 590 the record 580 as illustrated in (a) of FIG. 7.

In this case, the processor 130 may generate an integrated result value for the record 580 recorded at the first level in response to the case where the record 580 recorded at the first level is changed to the second level and is recorded 590 and record 650 the generated integrated result value in the output table 600 as illustrated in (b) of FIG. 7.

In this case, d1 of the record 580 of which the level is changed to the second level is “20” and d2 is “5”, so that “20” and “5” that are the median values of the respective records may be generated as the integrated result values and recorded 650 in the output table 600. The description of the particular numerical value of the integrated result value is simply illustrative, and the present disclosure is not limited thereto.

When all of the records are recorded at the highest level of the data structure, the processor 130 may calculate an integrated result value. For example, as illustrated in (a) of FIG. 7, when all of the records included in the sorted table 400 are recorded 590 at the second level that is the highest level of the data structure 500, the processor 130 may calculate an integrated result value of the record 590 recorded at the second level and record 660 the calculated integrated result value in the output table 600 as illustrated in (b) of FIG. 7.

That is, the output table in which the record is recorded according to the operations of the processor 130 may include the integrated output value for each level.

That is, the processor 130 may provide the output table including the integrated result value for each level for the records of a specific table through one-time calculation for the specific table.

Accordingly, it is possible to output a cumulative calculation value for each of the various levels for the records included in the table through the minimum amount of calculation, thereby improving efficiency of database processing performance. Further, when the present disclosure is applied to an analysis application, it is possible to more comparatively make a decision through the improvement of analysis performance, and contribute to improving competitiveness of a product related to big data through an analysis platform having high performance.

In the above-described examples and drawings, only the configuration for calculating and recording an integrated result value for each group with the second level of the data structure as the highest level is exemplarily described, however this is for convenience of explanation only, and the top level of the data structure in this disclosure is not limited to the second level. That is, it will be apparent to those skilled in the art that the data structure of the present disclosure may include additional levels beyond the second level, and that the integrated value may be calculated and recorded in response to additional levels beyond the second level.

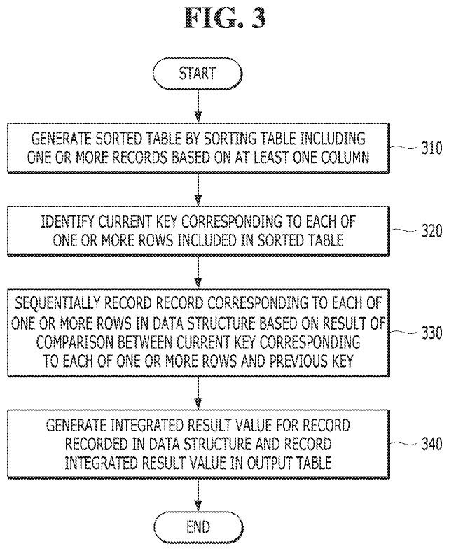

FIG. 3 is a flowchart illustrating an example of a method of managing a database according to an exemplary embodiment of the present disclosure.

According to the exemplary embodiment of the present disclosure, a computing device 100 may generate a sorted table by sorting a table including one or more records based on at least one column (310).

According to the exemplary embodiment of the present disclosure, the computing device 100 may identify a current key corresponding to each of the one or more rows included in the sorted table (320).

According to the exemplary embodiment of the present disclosure, the computing device 100 may sequentially record the record corresponding to each of the one or more rows in a data structure based on a result of a comparison between the current key and a previous key (330).

According to the exemplary embodiment of the present disclosure, the computing device 100 may output an integrated result value for the record recorded in the data structure and record the output integrated result value in an output table (340).

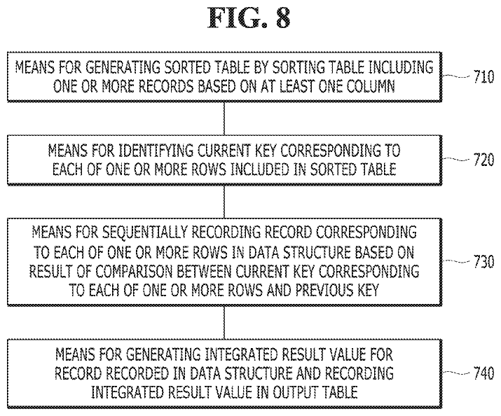

FIG. 8 is a diagram illustrating a means for performing a database management according to an exemplary embodiment of the present disclosure.

According to an exemplary embodiment of the present disclosure, a computer program may be implemented by a means described below.

According to the exemplary embodiment of the present disclosure, the computer program may include: a means 710 for generating a sorted table by sorting a table including one or more records based on at least one column, a means 720 for identifying a current key corresponding to each of the one or more rows included in the sorted table; a means 730 for sequentially recording the record corresponding to each of the one or more rows in a data structure based on a result of a comparison between the current key corresponding to each of the one or more rows and a previous key; and a means 740 for generating an integrated result value for the record recorded in the data structure and recording the generated integrated result value in an output table.

Alternatively, the data structure may include one or more levels, and a record of the sorted table may be recorded in each of the one or more levels.

Alternatively, the current key may be generated based on at least one column included in the sorted table, and include at least one of a reference key and a dependent key except for the reference key.

Alternatively, the means for sequentially recording the record corresponding to each of the one or more rows in the data structure based on the result of the comparison between the current key corresponding to each of the one or more rows and the previous key may include a means for determining a level at which a record of the sorted table is to be recorded in the data structure based on the result of the comparison between the current key and the previous key.

Alternatively, the means for sequentially recording the record corresponding to each of the one or more rows in the data structure based on the result of the comparison between the current key corresponding to each of the one or more rows and the previous key may include a means for recording a record of a row corresponding to the current key at the lowest level of the data structure when the previous key does not exist.

Alternatively, the means for sequentially recording the record corresponding to each of the one or more rows in the data structure based on the result of the comparison between the current key corresponding to each of the one or more rows and the previous key may include: a means for recording a record corresponding to the current key at the same level as that of the previous key in the data structure when the current key is the same as the previous key as the result of the comparison; and a means for recording a record corresponding to the current key at a level different from that of the previous key in the data structure when the current key is different from the previous key as the result of the comparison.

Alternatively, the means for sequentially recording the record corresponding to each of the one or more rows in the data structure based on the result of the comparison between the current key corresponding to each of the one or more rows and the previous key may include: a means for recording a record of a row corresponding to the current key at the lowest level of the data structure when the current key is the same as the previous key as the result of the comparison; and a means for recording a record pre-recorded at the lowest level of the data structure by changing the level of the pre-recorded record to a first level that is a higher level when the current key is different from the previous key as the result of the comparison, and recording a record of a row corresponding to the current key at the lowest level.

Alternatively, the means for recording the record pre-recorded at the lowest level of the data structure by changing the level of the pre-recorded record to the first level that is the higher level when the current key is different from the previous key as the result of the comparison, and the recording of the record of the row corresponding to the current key at the lowest level may include a means for recording the record recorded at the first level by changing the level of the record to a second level that is a higher level than the first level when an additional record is recorded at the first level.

Alternatively, the means for recording the record pre-recorded at the lowest level of the data structure by changing the level of the pre-recorded record to the first level that is the higher level when the current key is different from the previous key as the result of the comparison, and the recording of the record of the row corresponding to the current key at the lowest level may include: a means for determining whether a reference key of the current key matches a reference key of the previous key; and a means for recording the record recorded at the first level by changing the level of the record to the second level that is the higher level than the first level when the reference key of the current key is different from the reference key of the previous key.

Alternatively, the means for sequentially recording the record corresponding to each of the one or more rows in the data structure based on the result of the comparison between the current key corresponding to each of the one or more rows and the previous key may include a means for performing additional sorting on a record recorded at a different level when the level of the record located at each of the one or more levels is changed to the different level.

Alternatively, the means for generating the integrated result value for the record recorded in the data structure and recording the generated integrated result value in the output table may include: a means for comparing the current key with the previous key; and a means for generating an integrated result value for a record recorded at a level corresponding to the previous key in the data structure and recording the generated integrated result value in the output table when the current key is different from the previous key.

Alternatively, the means for generating the integrated result value for the record recorded in the data structure and recording the generated integrated result value in the output table may include: a means for comparing the current key with the previous key; a means for determining whether a reference key of the current key matches a reference key of the previous key; and a means for generating an integrated result value for a record at a higher level than the data structure and recording the generated integrated result value in the output table when the reference key of the current key is different from the reference key of the previous key.

Alternatively, the means for generating the integrated result value for the record recorded in the data structure and recording the generated integrated result value in the output table may include: a means for identifying a change in a level of the record recorded in the data structure; and a means for generating an integrated result value for the record of which the level is changed in response to the change in the level and recording the generated integrated result value in the output table.

Alternatively, the integrated result value is calculated based on the SQL received from a client, and may be a record value calculated for each level in response to a current key of each of the one or more rows.

According to an exemplary embodiment of the present disclosure, a means for performing a database management may also be implemented by a module, a circuit, or logic for implementing a computing device.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations has been generally described above in the functional aspects thereof. Whether the functionality is implemented as hardware or software depends on a specific application or design restraints given to the general system. Those skilled in the art may implement the functionality described by various methods for each of the specific applications, but it shall not be construed that the determinations of the implementation deviate from the range of the contents of the present disclosure.

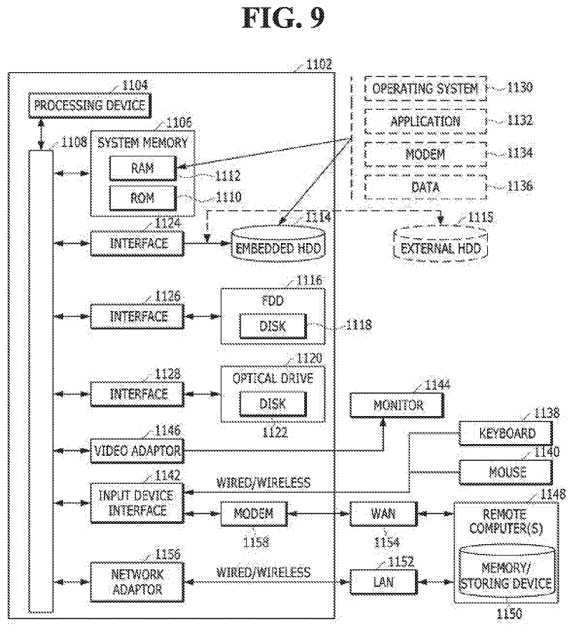

FIG. 9 is a simple and general schematic diagram illustrating an example of a computing environment in which the exemplary embodiments of the present disclosure are implementable.

The present disclosure has been generally described in relation to a computer executable command executable in one or more computers, but those skilled in the art will appreciate well that the present disclosure may be implemented in combination with other program modules and/or in a combination of hardware and software.

In general, a program module includes a routine, a procedure, a program, a component, a data structure, and the like performing a specific task or implementing a specific abstract data type. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be positioned in both a local memory storage device and a remote memory storage device.

The computer generally includes various computer readable media. A computer accessible medium may be a computer readable medium regardless of the kind of medium, and the computer readable medium may include a computer readable storage medium and a computer readable transport medium. The computer readable storage medium includes volatile and non-volatile media and portable and non-portable media. The computer readable storage medium includes volatile and non-volatile media, and portable and non-portable media constructed by a predetermined method or technology, which stores information, such as a computer readable command, a data structure, a program module, or other data. The computer readable storage medium includes a random access memory (RAM), a read only memory (ROM), electrically erasable and programmable ROM (EEPROM), a flash memory, or other memory technologies, a compact disc (CD)-ROM, a digital video disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally includes information transport media, which implement a computer readable command, a data structure, a program module, or other data in a modulated data signal in a modulated data signal, such as a carrier wave or other transport mechanisms. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, radio frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various common processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an erasable and programmable ROM (EPROM), and an EEPROM, and the BIOS includes a basic routine helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for outer mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. The interface 1124 for implementing an outer mounted drive includes at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of predetermined data in an appropriate digital form. In the description of the computer readable storage media, the HDD, the portable magnetic disk, and the portable optical media, such as a CD, or a DVD, are mentioned, but those skilled in the art will appreciate well that other types of compute readable storage media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display device are also connected to the system bus 1108 through an interface, such as a video adapter 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a server computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, Internet.

When the computer 1102 is used in the LAN networking environment, the computer 1102 is connected to the local network 1152 through a wired and/or wireless communication network interface or an adapter 1156. The adapter 1156 may make wired or wireless communication to the LAN 1152 easy, and the LAN 1152 also includes a wireless access point installed therein for the communication with the wireless adapter 1156. When the computer 1102 is used in the WAN networking environment, the computer 1102 may include a modem 1158, is connected to a communication server on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art will appreciate that the various illustrative logical blocks, modules, processors, means, circuits, and algorithm operations described in relation to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable device. For example, the computer-readable medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information. A term “machine-readable medium” includes a wireless channel and various other media, which are capable of storing, holding, and/or transporting a command(s) and/or data, but is not limited thereto.

It shall be understood that a specific order or a hierarchical structure of the operations included in the presented processes is an example of illustrative accesses. It shall be understood that a specific order or a hierarchical structure of the operations included in the processes may be re-arranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

What is claimed is:

1. A non-transitory computer readable medium including a computer program, the computer program causing a computer to perform operations for Database Management when executed by one or more processors, the operations including:
generating a sorted table by sorting a table including one or more records based on at least one column;
identifying a current key corresponding to each of one or more rows included in the sorted table;
sequentially recording records corresponding to each of the one or more rows to a data structure, based on a result of a comparison between a current key and a previous key corresponding to each of the one or more rows; and
generating an integrated result value for a record recorded in the data structure, and recording the result value in an output table.

2. The non-transitory computer readable medium according to claim 1,
wherein the data structure includes at least one level,
and a record of the sorted table is recorded in each of the one or more levels.

3. The non-transitory computer readable medium according to claim 1,
wherein the current key is generated based on at least one column included in the sorted table, and includes at least one of a reference key or a dependent key excluding the reference key.

4. The non-transitory computer readable medium according to claim 1,
wherein the sequentially recording records corresponding to each of the one or more rows to a data structure, based on a result of a comparison between a current key and a previous key corresponding to each of the one or more rows includes:
determining a level at which a record of the sorted table is to be recorded on the data structure based on a result of a comparison between the current key and the previous key.

5. The non-transitory computer readable medium according to claim 1,
wherein the sequentially recording records corresponding to each of the one or more rows to a data structure, based on a result of a comparison between a current key and a previous key corresponding to each of the one or more rows includes:
recording a record of a row corresponding to the current key to the lowest level of the data structure when the previous key does not exist.

6. The non-transitory computer readable medium according to claim 1,
wherein the sequentially recording records corresponding to each of the one or more rows to a data structure, based on a result of a comparison between a current key and a previous key corresponding to each of the one or more rows includes:
recording a record corresponding to the current key at the same level as the previous key on the data structure, when the current key and the previous key are matched as the result of a comparison; and
recording a record corresponding to the current key on the data structure at a level different from the previous key, when the current key is different from the previous key as the result of a comparison.

7. The non-transitory computer readable medium according to claim 1,
wherein the sequentially recording records corresponding to each of the one or more rows to a data structure, based on a result of a comparison between a current key and a previous key corresponding to each of the one or more rows includes:
recording a record of a row corresponding to the current key at a lowest level of the data structure, when the current key and the previous key are matched as the result of a comparison; and
recording a record pre-recorded at the lowest level of the data structure to a first level corresponding to a higher level, and recording a record of a row corresponding to the current key at the lowest level, when the current key is different from the previous key as the result of a comparison.

8. The non-transitory computer readable medium according to claim 7,
wherein the recording a record pre-recorded at the lowest level of the data structure to a first level corresponding to a higher level and recording a record of a row corresponding to the current key at the lowest level, when the current key is different from the previous key as the result of a comparison includes:
recording the record recorded in the first level by switching to a second level higher than the first level, when an additional record is recorded in the first level.

9. The non-transitory computer readable medium according to claim 7,
wherein the recording a record pre-recorded at the lowest level of the data structure to a first level corresponding to a higher level and recording a record of a row corresponding to the current key at the lowest level, when the current key is different from the previous key as the result of a comparison includes:
determining whether a reference key of the current key matches a reference key of the previous keys; and
recording the record recorded in the first level to a second level higher than the first level, when a reference key of the current key is different from a reference key of the previous key.

10. The non-transitory computer readable medium according to claim 1,
wherein the sequentially recording records corresponding to each of the one or more rows to a data structure, based on a result of a comparison between a current key and a previous key corresponding to each of the one or more rows includes:
performing an additional sort on a record recorded in a different level when a record located at each of the one or more levels is switched to a different level.

11. The non-transitory computer readable medium according to claim 1,
wherein the generating an integrated result value for a record recorded in the data structure, and recording the result value in an output table includes:
comparing the current key with the previous key; and
recording an integrated result value in the output table by generating the integrated result value for a record recorded at a level corresponding to the previous key in the data structure, when the current key is different from the previous key.

12. The non-transitory computer readable medium according to claim 1,
wherein the generating an integrated result value for a record recorded in the data structure, and recording the result value in an output table includes:
comparing the current key with the previous key;
determining whether a reference key of the current key matches a reference key of the previous key; and
recording an integrated result value in the output table by generating the integrated result value for a higher level record of the data structure, when a reference key of the current key is different from a reference key of the previous key.

13. The non-transitory computer readable medium according to claim 1,
wherein the generating an integrated result value for a record recorded in the data structure, and recording the result value in an output table includes:
identifying a level change of a record recorded in the data structure; and
recording an integrated result value in an output table by generating the integrated result value for a record in which the level change occurs in response to the level change.

14. The non-transitory computer readable medium according to claim 1,
wherein the integrated result value is
a record value calculated for each level corresponding to a current key of each of the one or more rows, and calculated based on a SQL (Structured Query Language) received from a client.

15. A server for Database Management, the server comprising:
a processor including one or more cores;
a memory for storing program codes executable by the processor; and
a network unit for transmitting and receiving data with a client;
wherein the processor is configured to:
generate a sorted table by sorting a table including one or more records based on at least one column;
identify a current key corresponding to each of one or more rows included in the sorted table;
sequentially record records corresponding to each of the one or more rows to a data structure, based on a result of a comparison between a current key and a previous key corresponding to each of the one or more rows; and
generate an integrated result value for a record recorded in the data structure, and recording the result value in an output table.

16. A method for Database Management, the method comprising:
generating a sorted table by sorting a table including one or more records based on at least one column;
identifying a current key corresponding to each of one or more rows included in the sorted table;
sequentially recording records corresponding to each of the one or more rows to a data structure, based on a result of a comparison between a current key and a previous key corresponding to each of the one or more rows; and
generating an integrated result value for a record recorded in the data structure, and recording the result value in an output table;
wherein the method is performed by one or more computing devices.
